(19) United States
(12) Patent Application Publication
(10) Pub. No.: US 2008/0143146 A1
(43) Pub. Date: Jun. 19, 2008

(54) Automobile Roof Shock Absorbing System

(76) Inventor: Abdulaziz Alagil, Morristown, NJ (US)

Correspondence Address: BOND, SCHOENECK & KING, PLLC, ONE LINCOLN CENTER, SYRACUSE, NY, 13202-1355, US

(21) Appl. No.: 11/943,116

(22) Filed: Nov. 20, 2007

Related U.S. Application Data
(60) Provisional application No. 60/869,791, filed on Dec. 13, 2006.

(51) Int. Cl. B60J 7/00; B60R 21/13; B60R 21/213; B60R 21/013

(52) U.S. Cl. 296/187.06; 296/210

(57) ABSTRACT

A system for preventing roof crush during a rollover type automobile accident. The system is a series of shock absorbing elements that are incorporated into each pillar of a vehicle and interconnect to the roof, and an airbag for detaching the roof apart from the vehicle just prior to a rollover event. During the rollover process, but prior to an actual rollover, the airbag deploys to detach the roof, which is supported by the series of shock absorbing elements. In the event that the vehicle completes the rollover or impacts an object or structure, the shock absorbing elements cushion the forces applied to the roof and prevent reduction of the available space of the passenger cabin. The shock absorbing elements also reduce bouncing of the vehicle by non-resiliently absorbing some of the force placed on the roof during a rollover.

### CROSS-REFERENCE TO RELATED APPLICATION

This application claims the benefit of U.S. Provisional Application No. 60/869,791, filed Dec. 13, 2006.

### BACKGROUND OF THE INVENTION

1. Field of the Invention

The present invention relates to automobile safety features and, more particularly, to a system for supporting the roof of an automobile during an accident.

2. Description of the Related Art

Roof crush injuries occur when the strength of the roof in a vehicle is inadequate or comprised during an accident and often results from rollover type automobile accidents. When the roof is crushed, it leaves minimal passenger survival space and may even open portal through which a person may be ejected from the vehicle. As roof crush injury risks are higher in vehicles with a greater propensity to rollover, the popularity of sports utility vehicles (SUVs) have increased the proportion of roof crush injuries inflicted on automobile passengers. Rollover accidents are regarded as highly survivable events, however, provided that the roof remains structurally sounds or the occupant compartment is not severely compromised.

Conventional systems for preventing roof crush injuries involve reinforcing the roof supporting structure. These systems add significant weight and expense to the vehicle, while sacrificing fuel economy. The most common system for alleviating roof crush injuries is to redesign the automobile to be less likely to roll over. This attempt to avoid the problem is not helpful, however, when the automobile actually does experience a rollover event.

### BRIEF SUMMARY OF THE INVENTION

It is therefore a principal object and advantage of the present invention to provide a system for preventing injuries caused by structural damage to an automobile roof.

It is an additional object and advantage of the present invention to provide a system for preventing injuries caused by structural damage to an automobile roof that is deployed during a rollover event.

In accordance with the foregoing objects and advantages, the present invention provides a system for preventing roof crush during a rollover type automobile accident comprising series of shock absorbing elements incorporated into each pillar of a vehicle and an airbag for detaching the roof apart from the vehicle just prior to a rollover event. The shock absorbing elements are interconnected to the roof and maintain the roof in a spaced apart position from the vehicle during a rollover. Prior to an actual rollover, the airbag deploys to detach the roof, which is then supported by the series of shock absorbing elements. In the event that the vehicle completes the rollover or impacts an object or structure, the shock absorbing element cushion the forces applied to the roof and prevent reduction of the available space of the passenger cabin. The shock absorbing elements have limited resiliency to prevent bouncing the vehicle after an initial impact.

### BRIEF DESCRIPTION OF THE DRAWINGS

The present invention will be more fully understood and appreciated by reading the following Detailed Description in conjunction with the accompanying drawings, in which:

FIG. 1 is a side view of an automobile equipped with a system according to the present invention.

FIG. 2 is a top view of a roof of an automobile equipped with a system according to the present invention.

FIG. 3 is a cross section of a shock absorbing element according to the present invention in a pre-deployed position.

FIG. 4 is a cross section of a shock absorbing element according to the present invention in a deployed position.

FIG. 5 is a top plan of a second embodiment of a shock absorbing element according to the present invention in a pre-deployed position.

FIG. 6A is a cross section of a second embodiment of a shock absorbing element according to the present invention in a pre-deployed position.

FIG. 6B is a cross section of a second embodiment of a shock absorbing element according to the present invention in a deployed position.

### DETAILED DESCRIPTION OF THE INVENTION

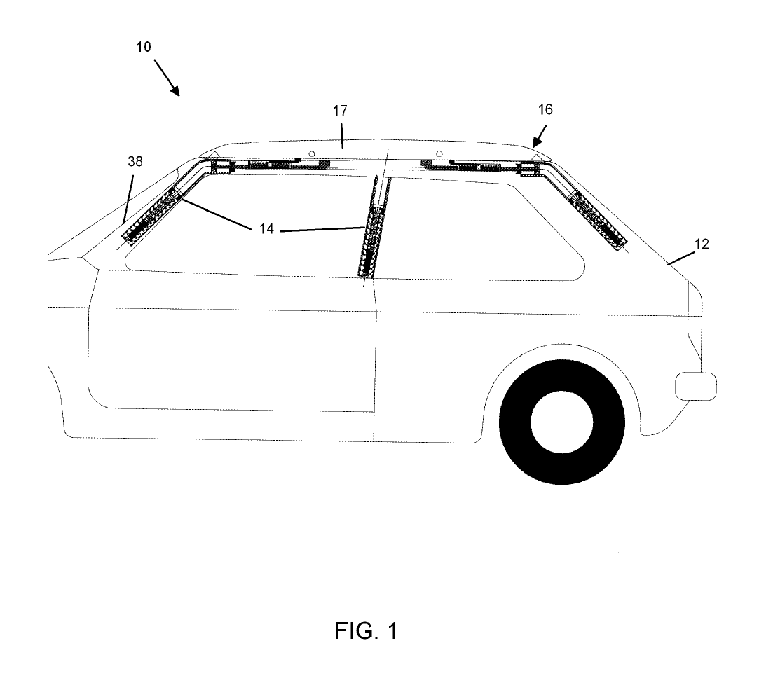

Referring now to the drawings, wherein like reference numerals refer to like parts throughout, there is seen in FIG. 1 a system 10 for reducing roof crush in a vehicle 12 during a roof crush event, such as a rollover type accident. System 10 comprises a plurality of shock absorbing elements 14 strategically positioned around vehicle 12 and interconnected to the roof 16 of vehicle 12. As will be described herein, elements 14 support roof 16 during a rollover type accident and protect the integrity of the passenger cabin of vehicle 12.

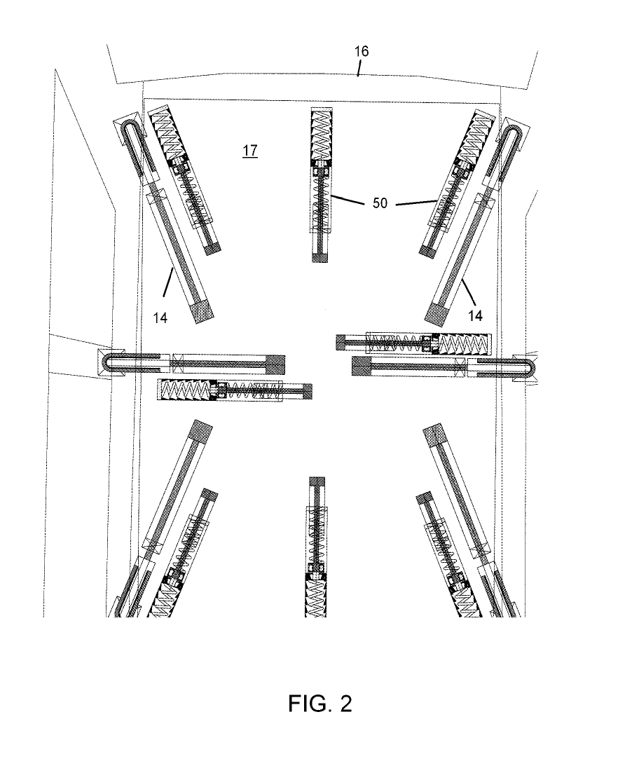

As seen in FIG. 2, multiple elements 14 may be positioned within the pillars of vehicle 12 and are interconnected to and hold roof 16 in place. An inflatable airbag (not shown) is invisibly positioned between vehicle 12 and roof 16 and is interconnected to conventional airbag driving sensors configured to detect a rollover type event. It should be recognized by those of skill in the art that the sensors may be programmed with any number of variable conditions based on the nature of vehicle 12 and the degree of motion associated with an impending rollover event. Roof 16 of vehicle 12 includes a central section 17 that is detachable from the periphery of roof 16. The inflatable airbag is positioned between section 17 and the remaining portion of roof 16.

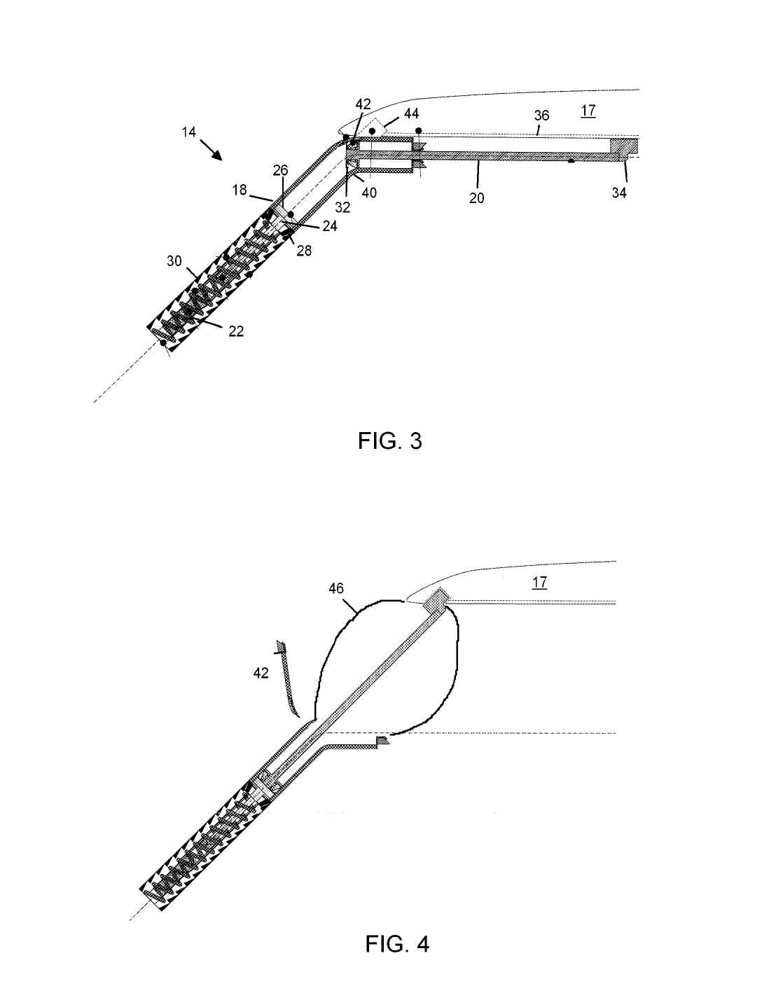

Referring to FIG. 3, a non-deployed shock absorbing element 14 comprises a tube 18 having a predetermined interior diameter and a rigid shaft 20 that is moveable into tube 18. Tube 18 houses a bias member 22, such as a compressible spring or gas cylinder, interconnected to a piston 24. Piston 24 preferably includes a magnetic cap 26 and tapered sides 28 for engaging a series of corresponding teeth 30 positioned on the interior surface of tube 18. Shaft 20 includes a magnetic head 32 at one end having a diameter corresponding to the interior diameter of shaft 20 for movement therein, and a pivoting guide 34 at the opposing end. Guide 34 of shaft 20 is interconnected to central section 17 via a track 36 formed therein along which guide 34 may slide. Tube 18 is positioned within the A pillar 38 of vehicle 10 and extends upwardly toward roof 16. Tube 18 preferably includes a joint 40 at the intersection of A-pillar 38 and roof 16 to provide for angular communication between the portion of tube 18 positioned in A-pillar 38 and the portion of tube 18 positioned in central section 17. Those of skill in the art with recognize that the degree of angular communication required will depend on the design of the particular automobile. Joint 40 includes a displaceable region 42 on its outwardly facing radius to allow shaft 20 to relocate during operation and easily descend into tube 18.

A deployed element 14 is seen in FIG. 4. Shaft 20 is positioned further within tube 18, thereby compressing bias member 22. Head 32 of shaft 20 is correspondingly deeper within tube 18 and is magnetically engaged with cap 26 of piston 24. Piston 24 is interlocked inside tube 18 through the action of tapered sides 28 and teeth 30 on the inside of tube 18. Displaceable region 42 of tube 18 has detached, thereby allowing shaft 20 to extend upwardly and space roof 16 apart from vehicle 12. Guide 34 of shaft 20 has moved along track 36 and is locked into a slot 44 formed into the end of track 36 of roof section 17. Previously invisible airbag 46 has inflated and is engaged with roof 16 and body of vehicle 12. Airbag 46 is preferably toroidally shaped to increase the available space within the passenger cabin of vehicle 12, and extends in the configuration seen in FIG. 4 entirely around the upper portion of the passenger cabin between roof 16 and central section 17, which is in the upwardly extended position. Notably, a portion of airbag 46 extends outwardly from perimeter of vehicle 12. In addition to supporting system 10 and further absorbing shock to vehicle 12 during an accident, the external curvature of airbag 46 encourages rotation of vehicle 12 during accident so that any resulting shock is more uniformly distributed across central section 17 and thus more readily absorbed by all of system 10.

Deployment of system 12 begins with a rollover type event. Conventional airbag motion sensors positioned in vehicle identify an impending rollover and trigger airbag 46 to inflate. The inflation of airbag 46 drives roof 16 upwardly away from vehicle 12. As roof 16 is drive upwardly, each element 14 is deployed. In particular, pivoting guide 34 slides along track 36 until shaft 20 extends substantially upward, displaceable region 42 of tube 18 is forcibly detached, and guide 34 locks into slot 44. Roof 16 has thus been raised away from vehicle 12, thereby significantly expanding the space of passenger compartment. Due to the speed by which airbag 46 is inflated, system 10 reaches the configuration of FIG. 4 prior to vehicle 12 overturning. If vehicle 12 actually rolls over and roof 14 impacts an object or structure, such as the ground, bias member 22 of shock absorbing element 14 absorbs the force of the impact as shaft 20 is driven into tube 18. The interlocking sides 28 of piston 24 and teeth 30 of tube 18 prevent bouncing of vehicle 12 by reducing the resilient effect of element 14 after any initial collision with an object or structure.

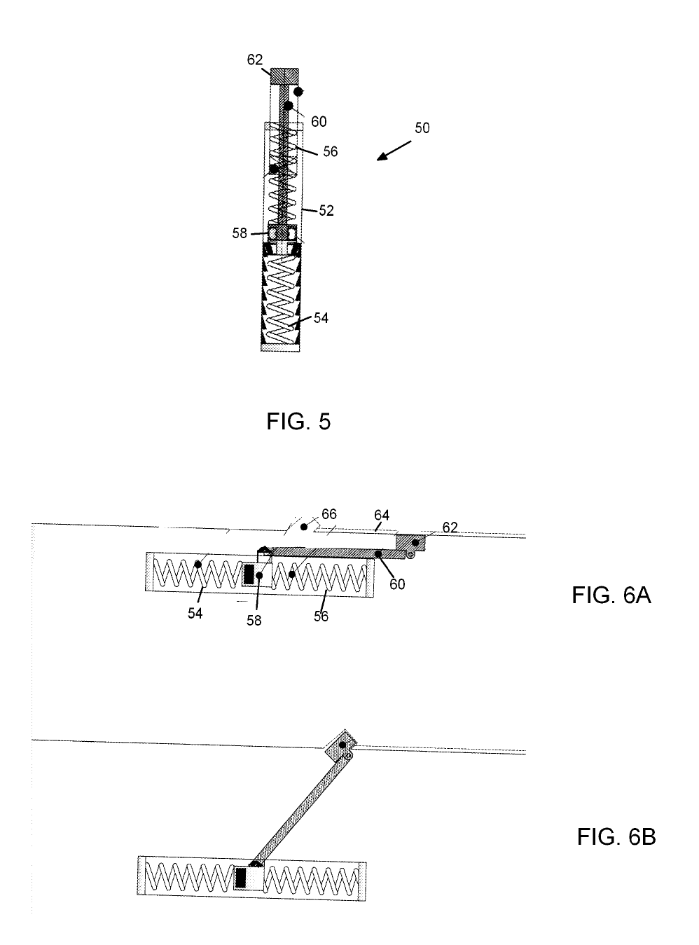

Referring again to FIG. 2, another embodiment of system 10 may comprise a series of resilient members 50 spaced apart around roof section 17. Referring to FIG. 5, each resilient member 50 comprises a tube 52 including first and second bias members 54 and 56, respectively, positioned on either side of a block 58. Bias member 54 is preferably designed to provide a compression force, while bias member 56 is preferably designed to provide a tensional force. A shaft 60 is interconnected to block 58 at one end, and is interconnected to roof section 17 via a head 62 positioned in a track 64 formed in roof section 17. As seen in FIG. 6, track 64 further includes a slot 66 for receiving head 62 and locking it in place when member 50 is in a deployed position. Members 50 may be included in addition to the elements 14 as seen in FIG. 1 to provide sufficient support of central section during a rollover accident.

What is claimed is:

1. An automobile having improved protection against accidents, comprising:
a frame defining a passenger compartment;
a roof positioned over said passenger compartment;
an inflatable member interconnected to said roof and said frame; and
a supporting member interconnected to said roof and said frame.

2. The automobile of claim 1, wherein said supporting member comprises:
a tube interconnected to said frame; and
a shaft having a first end interconnected to said roof and a second end extending at least partially into said tube.

3. The automobile of claim 2, wherein said supporting member further comprises a piston positioned in said tube and a spring interconnecting said tube and said piston.

4. The automobile of claim 3, wherein said roof includes a track in which the first end of said shaft is slidingly engaged.

5. The automobile of claim 4, wherein said second end of said shaft includes a tapered cap positioned thereon and said tube includes a plurality of teeth for engaging said head.

6. The automobile of claim 5, wherein said piston includes a head positioned thereon, and said head and said cap are formed of magnetic material such that said head and said cap will become magnetically engaged when positioned in proximity to each other.

7. The automobile of claim 6, wherein said first end of said shaft is slidingly and pivotally engaged to said track.

8. The automobile of claim 7, further comprising a sensor interconnected to said inflatable member for triggering inflation of said member in the event of a predetermined condition.

9. The automobile of claim 8, wherein inflation of said inflatable member detaches at least a portion of said roof from said frame, thereby enlarging the passenger compartment.

10. The automobile of claim 4, further comprising:
a second tube having first and second ends;
a block positioned in said tube for movement therein;
a first bias member interconnecting said first end of said second tube to said block;
a second bias member interconnecting said second end of said second tube to said block; and
a shaft interconnected to said block and extending outwardly from an intermediate location of said second tube to engage said roof.

11. The automobile of claim 10, wherein said roof includes a second track in which said second shaft is slidingly engaged.

12. The automobile of claim 11, further comprising a slot in said second track for retaining said second shaft when said second shaft slides along said track to a predetermined location.

13. A shock absorbing system for an automobile having a frame and a roof, said system comprising:
a tube configured for interconnection to said frame; and
a shaft having a first end configured for interconnection to said roof and a second end extending at least partially into said tube;
a piston positioned in said tube; and
a spring interconnecting said tube and said piston.

14. The system of claim 13, wherein said second end of said shaft includes a tapered cap positioned thereon and said tube includes a plurality of teeth for engaging said head.

15. The system of claim 14, wherein said piston includes a head positioned thereon, and said head and said cap are formed of magnetic material such that said head and said cap will become magnetically engaged when positioned in proximity to each other.

16. The system of claim 15, wherein said first end of said shaft includes a member pivotally positioned thereon for slidingly engaging a track in said roof.

17. The system of claim 16, wherein said first end of said shaft includes a member that slidingly and pivotally engages said track.
